(19) United States
(12) Patent Application Publication
(10) Pub. No.: US 2024/0319558 A1
(43) Pub. Date: Sep. 26, 2024

(54) OPTICAL WAVEGUIDE ELEMENT, OPTICAL MODULATOR, OPTICAL MODULATION MODULE, AND OPTICAL TRANSMISSION DEVICE

(71) Applicant: SUMITOMO OSAKA CEMENT CO., LTD., Tokyo (JP)

(72) Inventors: Norikazu Miyazaki, Tokyo (JP); Toru Sugamata, Tokyo (JP)

(21) Appl. No.: 18/258,272

(22) PCT Filed: Dec. 23, 2021
(86) PCT No.: PCT/JP2021/047958

§ 371 Date: Jun. 19, 2023

(30) Foreign Application Priority Data
Dec. 23, 2020 (JP) 2020-214027

(51) Int. Cl. G02F 1/225; G02F 1/01; G02F 1/21

(52) U.S. Cl. CPC G02F 1/2252; G02F 1/0121; G02F 1/212; G02F 1/2255

(57) ABSTRACT

In an optical waveguide device having a plurality of intersections between a convex optical waveguide and a signal electrode, the generation of disturbance modulation at the intersections is effectively reduced, thereby achieving good operating characteristics. An optical waveguide device includes a substrate on which an optical waveguide is formed, an intermediate layer formed on the substrate, and a signal electrode and a ground electrode formed on the intermediate layer, in which the optical waveguide includes a protruding portion extending on the substrate, the signal electrode has an action portion that extends along the optical waveguide and controls a light wave propagating through the optical waveguide, and an intersection that crosses over the optical waveguide, and the intermediate layer is formed such that a thickness at the intersection is thicker than a thickness at the action portion.

### TECHNICAL FIELD

The present invention relates to an optical waveguide device, an optical modulator, an optical modulation module, and an optical transmission apparatus.

### BACKGROUND ART

In a high-frequency and large-capacity optical fiber communication system, an optical modulator incorporating an optical modulation device as an optical waveguide device including an optical waveguide formed on a substrate and a control electrode for controlling a light wave propagating in the optical waveguide is often used. Among these, optical modulation devices in which LiNbO₃ (hereinafter, also referred to as LN) having an electro-optic effect is used for substrates has a small optical loss and can realize a broadband optical modulation characteristic, so the optical modulation devices are widely used for high-frequency/large-capacity optical fiber communication systems.

In particular, due to the increasing transmission capacity in recent years, the mainstream of modulation methods in optical fiber communication systems is multi-level modulation and the transmission format adopting polarized wave multiplexing for multi-level modulation, such as Quadrature Phase Shift Keying (QPSK) and Dual Polarization-Quadrature Phase Shift Keying (DP-QPSK), which are used in fundamental optical transmission networks and is also being introduced into metro networks.

Further, in recent years, in order to implement further low-voltage driving and high-frequency modulation while miniaturizing the optical modulator itself, optical modulators using a rib-type optical waveguide or ridge optical waveguide (hereinafter collectively referred to as convex optical waveguides) formed by forming strip-shaped protruding portions on the surface of a thinned LN substrate (thin plate) (for example, a thickness of 20 μm or less) to further strengthen the interaction between the signal electric field and the guided light in the substrate are also being put to practical use (for example, Patent Literatures No. 1 and No. 2).

Further, in addition to reducing the size of the optical modulation device, for example, efforts are underway to house an electronic circuit and an optical modulation device in one housing and to integrate them into an optical modulation module. For example, an optical modulation module designed to be miniaturized and integrated has been proposed in which an optical modulation device and a high-frequency driver amplifier driving the optical modulation device are integrated and housed in one housing, and optical input and output portions are disposed in parallel on one surface of the housing. In the optical modulation device used in such an optical modulation module, the optical waveguide is formed on the substrate such that the light propagation direction is folded back such that an optical input end and an optical output end of the optical waveguide are disposed on one side of the substrate configuring the optical modulation device (for example, Patent Literature No. 3). Hereinafter, an optical modulation device including an optical waveguide including such a folded portion in the light propagation direction will be referred to as a folded optical modulation device.

Incidentally, an optical modulator that performs QPSK modulation (QPSK optical modulator) and an optical modulator that performs DP-QPSK modulation (DP-QPSK optical modulator) each include a plurality of Mach-Zehnder optical waveguides having a so-called nested structure called a nested type, which has at least one signal electrode to which a high-frequency signal is applied. The signal electrode formed on the substrate generally forms, for example, a coplanar transmission line together with ground electrodes extending with the signal electrode interposed therebetween in the substrate surface. In this case, in order to maintain the impedance of the coplanar transmission line constant in the substrate surface, the signal electrode and the ground electrode are formed to maintain a constant clearance in the surface of the substrate (see, for example, FIG. 1 of Patent Literature No. 3). Further, in a case where the signal electrode and the ground electrode are formed on the intermediate layer such as the buffer layer formed on the substrate surface, the intermediate layer is generally formed to have a uniform thickness in the substrate surface for the same reason as described above.

Further, these signal electrodes are formed to extend to the vicinity of the outer periphery of the LN substrate for connection with an electric circuit outside the substrate. Therefore, on the substrate, the plurality of optical waveguides and the plurality of signal electrodes intersect in a complicated manner, and a plurality of intersections where the signal electrodes traverse the optical waveguides are formed.

At such intersections, an electric field is applied from the signal electrode crossing over the optical waveguide to the portion of the optical waveguide below the signal electrode, and the phase of the light propagating through the optical waveguide is slightly changed and modulated. The phase change or phase modulation of light at such an intersection may act as noise for the optical phase change for normal modulation generated in the optical waveguide by the signal electrode and disturb the optical modulation operation. Hereinafter, phase modulation due to noise generated at such an intersection is referred to as disturbance modulation.

The degree of the noise effect of the disturbance modulation on the optical modulation operation in the optical modulator is larger as the electric field applied from the signal electrode to the optical waveguide at the intersection is stronger, and also increases due to addition effects proportional to the number of intersections (for example, depending on the sum of the lengths of intersections (intersection lengths) along the signal electrodes).

For example, while in a configuration in the related art in which an optical waveguide formed by diffusing a metal such as Ti on the flat surface of an LN substrate (so-called planar optical waveguide) intersects with a signal electrode formed on the substrate plane of the LN substrate, the signal electrode is formed only on the upper surface (substrate surface) of the optical waveguide, in a configuration in which the convex optical waveguide and the signal electrode intersect as described above, the signal electrode can also be formed on the upper surface and two side surfaces of the protruding portion of the convex optical waveguide. Therefore, since the electric field applied from the signal electrode to the optical waveguide at the intersection is stronger in the case of the convex optical waveguide than in the case of the planar optical waveguide, the noise due to the disturbance modulation can occur larger in the convex optical waveguide than in the case of the planar optical waveguide.

Further, in the folded optical modulation device as described above, there are more intersections between the electrode and the optical waveguide than in a non-folded optical modulation device formed of an optical waveguide that does not include a light folded portion (for example, see FIG. 1 of Patent Literature No. 3), so that the noise due to the disturbance modulation can be larger. For example, in the case of the DP-QPSK modulation element described above, while in the non-folded optical modulation device, the number of intersections in one electrode is about 2 to 4, and the total intersection length is several tens of microns (for example, a range from 20 μm to 40 μm), in the folded optical modulation device, the number of intersections in one electrode may reach a several tens, and the total intersection length may be several hundred microns to several millimeters.

Therefore, particularly in the folded optical modulation device configured by using the convex optical waveguide, the noise due to the disturbance modulation generated at the intersection may be so large that it cannot be ignored for the normal optical modulation operation.

In addition, the above intersections can also be formed in various optical waveguide devices such as optical waveguide devices using a semiconductor such as InP as a substrate and silicon photonics waveguide devices using Si as a substrate, as well as the LN substrates. Moreover, such optical waveguide devices may be various optical waveguide devices such as optical modulators using Mach-Zehnder optical waveguides, optical modulators using optical waveguides forming a directional coupler or a Y branch, or optical switches.

Then, when the optical waveguide pattern and the electrode pattern become complicated due to further miniaturization, multi-channelization, and/or high integration of the optical waveguide device, the number of intersections on the substrate increases more and more, and noise due to disturbance modulation may become a non-negligible factor and limit the performance of the optical waveguide device.

### CITATION LIST

### Patent Literature

[Patent Literature No. 1] Japanese Laid-open Patent Publication No. 2007-264548
[Patent Literature No. 2] Pamphlet of International Publication No. WO2018/031916
[Patent Literature No. 3] Japanese Laid-open Patent Publication No. 2019-152732

### SUMMARY OF INVENTION

### Technical Problem

From the above background, in an optical waveguide device having a plurality of intersections between a convex optical waveguide and a signal electrode for propagating an electrical signal, it is required to effectively reduce the generation of disturbance modulation at the intersections to achieve good operating characteristics.

### Solution to Problem

One aspect of the present invention is an optical waveguide device including: a substrate on which an optical waveguide is formed; an intermediate layer formed on the substrate; and a signal electrode and a ground electrode formed on the intermediate layer, wherein the optical waveguide includes a protruding portion extending on the substrate, the signal electrode has an action portion that extends along the optical waveguide and controls a light wave propagating through the optical waveguide, and an intersection that crosses over the optical waveguide, and the intermediate layer is formed such that a thickness at the intersection is thicker than a thickness at the action portion.

According to another aspect of the present invention, the intermediate layer may be formed such that the thickness of the intermediate layer stepwise and/or continuously increases from the action portion toward the intersection.

According to another aspect of the present invention, the intermediate layer may be formed of one or a plurality of layers, and the intermediate layer may be formed such that the number of layers at the intersection is larger than the number of layers at the action portion.

According to another aspect of the present invention, the intermediate layer may include a resin layer at the intersection.

According to another aspect of the present invention, the intermediate layer may be formed such that the thickness at the intersection is thicker than a height of the protruding portion forming the optical waveguide.

According to another aspect of the present invention, the ground electrode may be formed such that a clearance between the ground electrode and the signal electrode is wider at the intersection than at the action portion.

Another aspect of the present invention is an optical waveguide device including: a substrate on which an optical waveguide is formed; an intermediate layer formed on the substrate; and a signal electrode and a ground electrode formed on the intermediate layer, wherein the optical waveguide includes a protruding portion extending on the substrate, the signal electrode has an action portion that extends along the optical waveguide and controls a light wave propagating through the optical waveguide, and an intersection that crosses over the optical waveguide, and the ground electrode is formed such that a clearance between the ground electrode and the signal electrode is wider at the intersection than at the action portion.

According to another aspect of the present invention, the ground electrode may be formed such that the clearance between the ground electrode and the signal electrode is stepwise and/or continuously widened from the action portion toward the intersection.

According to another aspect of the present invention, the ground electrode may be formed such that the clearance between the ground electrode and the signal electrode at the intersection is wider than three times a width of the protruding portion forming the optical waveguide.

Another aspect of the present invention is an optical modulator including: the optical waveguide device according to any one of the above aspects, which is an optical modulation device that modulates light; a housing that houses the optical waveguide device; an optical fiber that inputs light to the optical waveguide device; and an optical fiber that guides light output by the optical waveguide device to outside the housing.

Another aspect of the present invention is an optical modulation module including: the optical waveguide device according to any one of the above aspects, which is an optical modulation device that modulates light; and a drive circuit that drives the optical waveguide device.

Still another aspect of the present invention is an optical transmission apparatus including: the optical modulator or the optical modulation module; and an electronic circuit that generates an electrical signal for causing the optical waveguide device to perform a modulation operation.

This specification includes all the contents of Japanese Patent Application No. 2020-214027 filed on Dec. 23, 2020.

### Advantageous Effects of Invention

According to the present invention, in an optical waveguide device having a plurality of intersections between a convex optical waveguide and an electrode for propagating an electrical signal, the generation of disturbance modulation at the intersections is effectively reduced, thereby achieving good operating characteristics.

### BRIEF DESCRIPTION OF DRAWINGS

FIG. 1 is a diagram illustrating a configuration of an optical modulator according to a first embodiment of the present invention.

FIG. 2 is a diagram illustrating a configuration of an optical modulation device used in the optical modulator illustrated in FIG. 1.

FIG. 3 is a partial detailed view of an optical modulator unit A of the optical modulation device illustrated in FIG. 2.

FIG. 4 is a partial detailed view of an optical folded part B illustrated in FIG. 2.

FIG. 5 is a cross-sectional view taken along line V-V of the optical modulator unit A illustrated in FIG. 3.

FIG. 6 is a cross-sectional view taken along line VI-VI of the optical folded part B shown in FIG. 4.

FIG. 7 is a cross-sectional view taken along line VII-VII of the optical folded part B shown in FIG. 4.

FIG. 8 is a view corresponding to the cross-sectional view taken along line V-V shown in FIG. 5, according to a modification example of the optical modulation device shown in FIG. 2.

FIG. 9 is a diagram corresponding to the cross-sectional view taken along line VI-VI shown in FIG. 6, according to a modification example of the optical modulation device shown in FIG. 2.

FIG. 10 is a diagram corresponding to the cross-sectional view taken along line VII-VII shown in FIG. 7, according to a modification example of the optical modulation device shown in FIG. 2.

FIG. 11 is a diagram illustrating a configuration of an optical modulator according to a second embodiment of the present invention.

FIG. 12 is a diagram illustrating a configuration of an optical modulation device used in the optical modulator illustrated in FIG. 11.

FIG. 13 is a partial detailed view of an optical modulator unit C of the optical modulation device illustrated in FIG. 12.

FIG. 14 is a partial detailed view of an optical folded part D of the optical modulation device illustrated in FIG. 12.

FIG. 15 is a cross-sectional view taken along line XV-XV of the optical modulator unit C illustrated in FIG. 13.

FIG. 16 is a cross-sectional view taken along line XVI-XVI of the optical folded part D shown in FIG. 14.

FIG. 17 is a diagram showing one signal electrode and a ground electrode adjacent to the signal electrode, extracted from the optical modulation device illustrated in FIG. 12.

FIG. 18 is a diagram illustrating a configuration of an optical modulation module according to a third embodiment of the present invention.

FIG. 19 is a diagram illustrating a configuration of an optical transmission apparatus according to a fourth embodiment of the present invention.

### DESCRIPTION OF EMBODIMENTS

Hereinafter, embodiments of the present invention will be described with reference to the drawings.

### First Embodiment

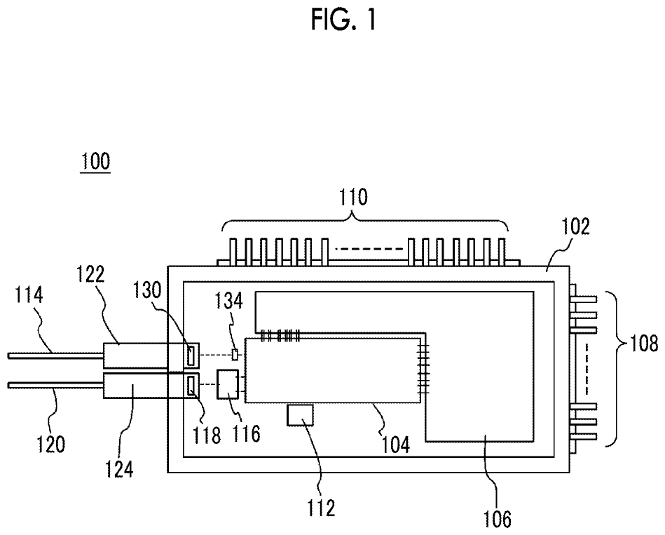

First, a first embodiment will be described. FIG. 1 is a diagram illustrating a configuration of an optical modulator 100 using an optical modulation device, which is an optical waveguide device according to a first embodiment of the present invention. The optical modulator 100 includes a housing 102, an optical modulation device 104 housed in the housing 102, and a relay substrate 106. The optical modulation device 104 is, for example, a configuration of a DP-QPSK modulator. Finally, a cover (not shown), which is a plate body, is fixed to the opening of the housing 102, and the inside of the housing 102 is hermetically sealed.

The optical modulator 100 has signal pins 108 for receiving a high-frequency electrical signal used for modulation of the optical modulation device 104, and signal pins 110 for inputting an electrical signal used for adjusting the operating point of the optical modulation device 104.

Further, the optical modulator 100 includes an input optical fiber 114 for inputting light into the housing 102 and an output optical fiber 120 for guiding the light modulated by the optical modulation device 104 to the outside of the housing 102 on the same surface of the housing 102.

Here, the input optical fiber 114 and the output optical fiber 120 are fixed to the housing 102 via the supports 122 and 124 which are fixing members, respectively. The light input from the input optical fiber 114 is collimated by the lens 130 disposed in the support 122, and then input to the optical modulation device 104 via the lens 134. However, this is only an example, and the input of light to the optical modulation device 104 may be performed by introducing, for example, the input optical fiber 114 into the housing 102 via the support 122, and connecting the end face of the introduced input optical fiber 114 to the end face of the substrate 220 (described later) of the optical modulation device 104, according to the related art.

The optical modulator 100 also has an optical unit 116 that polarizes and synthesizes two beams of modulated light output from the optical modulation device 104. The light after polarization synthesis, output from the optical unit 116, is collected by the lens 118 disposed in the support 124 and coupled to the output optical fiber 120.

The relay substrate 106 relays the high-frequency electrical signal input from the signal pins 108 and the electrical signal for adjusting an operating point input from the signal pins 110 to the optical modulation device 104, according to a conductor pattern (not shown) formed on the relay substrate 106. The conductor pattern on the relay substrate 106 is connected to a pad (described later) configuring one end of the electrode of the optical modulation device 104 by wire bonding or the like, for example. Further, the optical modulator 100 includes a terminator 112 having a predetermined impedance in the housing 102.

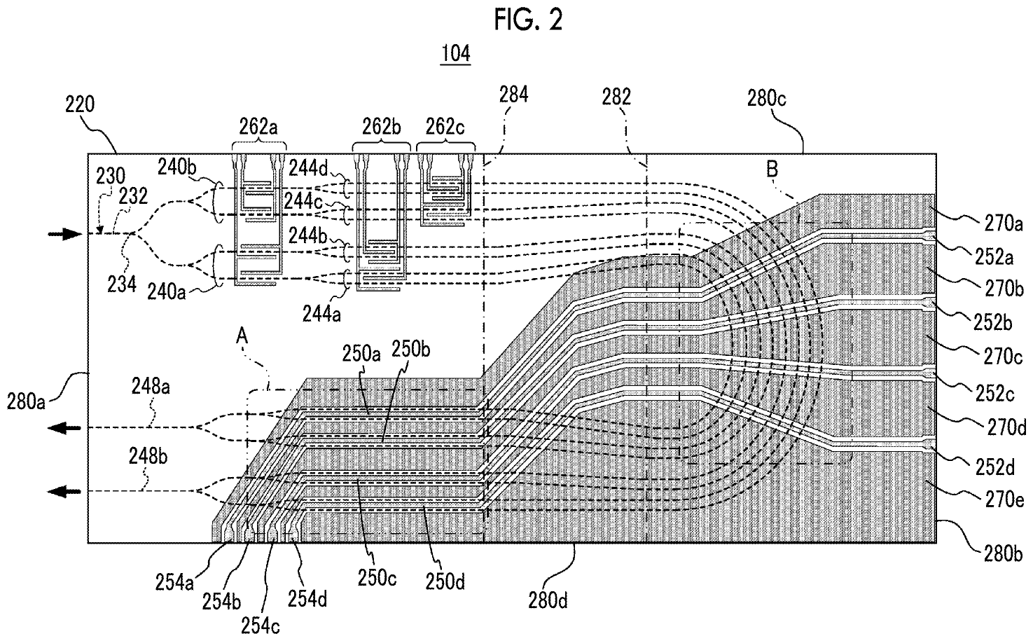

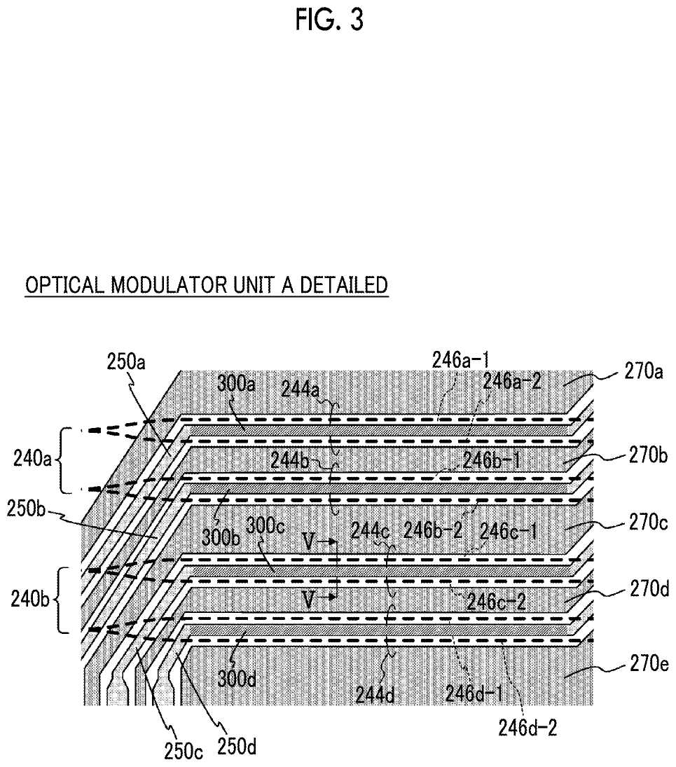

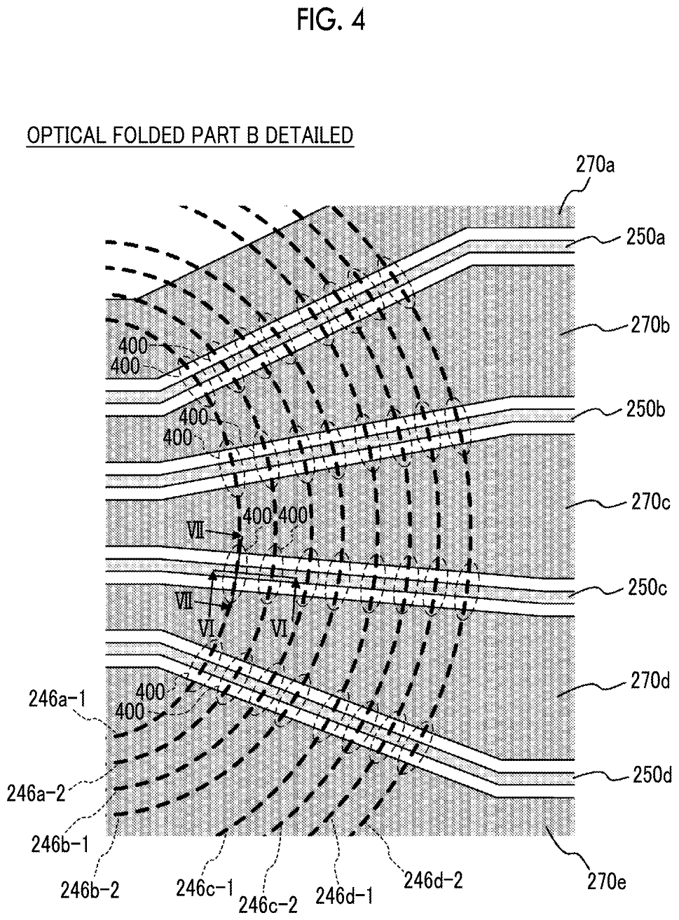

FIG. 2 is a diagram illustrating an example of the configuration of the optical modulation device 104, which is housed in the housing 102 of the optical modulator 100 illustrated in FIG. 1. Further, FIGS. 3 and 4 are partial detailed views of the optical modulator unit A and the optical folded part B of the optical modulation device 104 shown in FIG. 2, respectively.

The optical modulation device 104 is formed of an optical waveguide 230 (the shown entire bold dotted line) formed on a substrate 220, and performs, for example, 200G DP-QPSK modulation. The substrate 220 is, for example, a thinned X-cut LN substrate having an electro-optic effect, which is processed to a thickness of 20 μm or less (for example, 2 μm). The optical waveguide 230 is a convex optical waveguide (for example, a rib-type optical waveguide or a ridge optical waveguide) including a strip-shaped extending protruding portion formed on the surface of the thinned substrate 220. Here, since in the LN substrate, the refractive index can locally change due to the photoelastic effect when stress is applied, the LN substrate is generally adhered to a silicon (Si) substrate, a glass substrate, an LN supporting plate, or the like in order to reinforce the mechanical strength of the entire substrate. In the present embodiment, as will be described later, the substrate 220 is adhered to the supporting plate 500.

The substrate 220 is, for example, rectangular and has two left and right sides 280a and 280b extending in the vertical direction and facing each other, and upper and lower sides 280c and 280d extending in the left and right direction and facing each other, in the drawing.

The optical waveguide 230 includes an input waveguide 232 that receives the input light (arrow pointing to the right) from the input optical fiber 114 on the upper side of the left side 280a of the substrate 220, and a branched waveguide 234 that branches the input light into two light beams having the same light amount, in the drawing. Further, the optical waveguide 230 includes a so-called nested Mach-Zehnder optical waveguides 240a and 240b, which are two modulation parts for modulating each light branched by the branched waveguide 234.

The nested Mach-Zehnder optical waveguides 240a and 240b respectively include two Mach-Zehnder optical waveguides 244a and 244b, and 244c and 244d respectively provided in two waveguide parts forming a pair of parallel waveguides. As shown in FIG. 3, the Mach-Zehnder optical waveguides 244a and 244b have parallel waveguides 246a-1 and 246a-2 and parallel waveguides 246b-1 and 246b-2, respectively. Further, the Mach-Zehnder optical waveguides 244c and 244d have parallel waveguides 246c-1 and 246c-2 and parallel waveguides 246d-1 and 246d-2, respectively.

Hereinafter, the nested Mach-Zehnder optical waveguides 240a and 240b are collectively referred to as a nested Mach-Zehnder optical waveguide 240, and the Mach-Zehnder optical waveguides 244a, 244b, 244c, and 244d are collectively referred to as a Mach-Zehnder optical waveguide 244. Further, the parallel waveguides 246a-1, 246a-2, 246b-1, 246b-2, 246c-1, 246c-2, 246d-1 and 246d-2 are collectively referred to as parallel waveguides 246.

As shown in FIG. 2, the nested Mach-Zehnder optical waveguide 240 includes an optical modulator unit A and an optical folded part B (each of which is a part indicated by a rectangular shape of a shown two-dot chain line). In the nested Mach-Zehnder optical waveguide 240, each of the input light branched into two beams by the branched waveguide 234 is QPSK-modulated in the optical modulator unit A after the light propagation direction is folded back by 180 degrees in the optical folded part B, and then the modulated light (output) is output from the respective output waveguides 248a and 248b to the left in the drawing. These two output light beams are then polarized and synthesized by an optical unit 116 disposed outside the substrate 220 and are combined into one light beam.

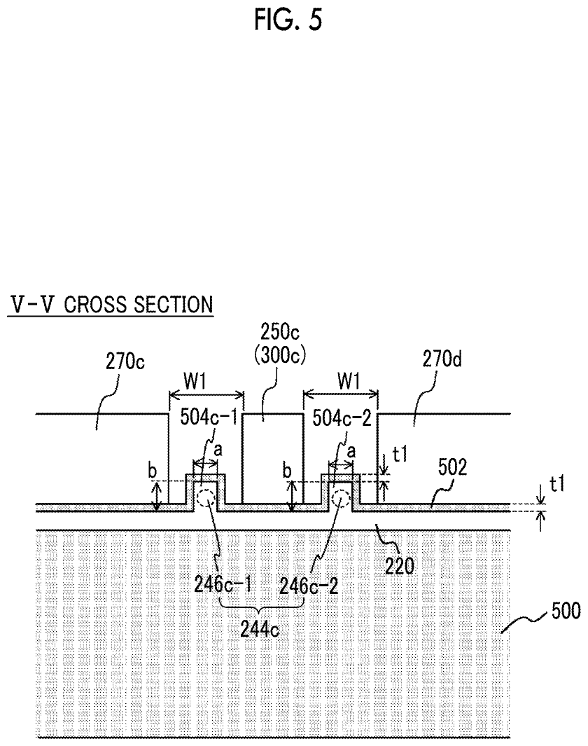

An intermediate layer 502 to be described later is formed on the substrate 220 (FIG. 5), and four signal electrodes 250a, 250b, 250c, and 250d are provided on the intermediate layer 502 to receive high-frequency electrical signals for respectively causing total four Mach-Zehnder optical waveguides 244a, 244b, 244c, and 244d configuring the nested Mach-Zehnder optical waveguides 240a and 240b to perform modulation operations (FIG. 2).

Specifically, in the optical modulator unit A shown in FIG. 3, the signal electrode 250a is located between the parallel waveguides 246a-1 and 246a-2 configuring the Mach-Zehnder optical waveguide 244a, has an action portion 300a (shown hatched portion) extending along these parallel waveguides, and causes a Mach-Zehnder optical waveguide 244a to perform a modulation operation. Similarly, the signal electrodes 250b, 250c, and 250d are respectively located between the two parallel waveguides 246 configuring the Mach-Zehnder optical waveguides 244b, 244c, and 244d in the optical modulator unit A, have action portions 300b, 300c, and 300d extending along these parallel waveguides, and cause the Mach-Zehnder optical waveguides 244b, 244c, and 244d to perform a modulation operation. Hereinafter, the action portions 300a, 300b, 300c, and 300d are collectively referred to as the action portion 300.

In FIG. 2, the signal electrodes 250a, 250b, 250c, and 250d extend to the right of the substrate 220, cross over the eight parallel waveguides 246 in the optical folded part B, and then, extend to the side 280b and are connected to the pads 252a, 252b, 252c, and 252d (FIGS. 2 and 4). As shown in FIG. 4, each of the signal electrodes 250a, 250b, 250c, and 250d crosses over eight parallel waveguides 246 in the optical folded part B to form eight intersections 400 (portions indicated by the shown dotted ellipses). Here, in FIG. 4, in order to avoid redundant representation and facilitate understanding, reference numerals 400 are attached only to the intersections between the signal electrode 250 and the parallel waveguides 246a-1 and 246a-2, but it should be understood that the intersections between the signal electrode 250 and the other parallel waveguides 246 shown by the same dotted ellipses in the drawing are also the intersections 400. Therefore, in FIG. 4, a total of 32 intersections 400 exist.

That is, the signal electrode 250 has an action portion 300 that extends along the parallel waveguide 246 and controls a light wave propagating through the parallel waveguide 246, and an intersection 400 that crosses over the parallel waveguide 246.

With reference to FIG. 2, the left sides of the signal electrodes 250a, 250b, 250c, and 250d are bent downward to extend to the side 280d of the substrate 220, and are connected to the pads 254a, 254b, 254c, and 254d.

The signal electrodes 250a, 250b, 250c, and 250d and the ground electrodes 270a, 270b, 270c, 270d, and 270e which are formed to respectively sandwich the signal electrodes 250a, 250b, 250c, and 250d on the surface of the substrate 220 in accordance with the related art configure, for example, a coplanar transmission line having a predetermined impedance. Hereinafter, the ground electrodes 270a, 270b, 270c, 270d, and 270e are collectively referred 5 to as ground electrodes 270.

The pads 252a, 252b, 252c, and 252d arranged on the right side 280b in FIG. 2 are connected to the relay substrate 106 by wire bonding or the like. The pads 254a, 254b, 254c, and 254d arranged on the shown lower side 280d are connected to four termination resistors (not shown) forming the terminator 112, respectively. Thus, the high-frequency electrical signals input from the signal pin 108 to the pads 252a, 252b, 252c, and 252d via the relay substrate 106 become traveling waves to propagate through the signal electrodes 250a, 250b, 250c, and 250d, and modulate the light waves propagating through the Mach-Zehnder optical waveguides 244a, 244b, 244c, and 244d, respectively, in the action portions 300a, 300b, 300c, and 300d.

Here, the substrate 220 is formed in a thickness of 20 μm or less, preferably 10 μm or less, such that the interaction between the electric field formed in the substrate 220 by the signal electrodes 250 and the guided light propagating through the Mach-Zehnder optical waveguides 244 is further strengthened to perform a high-frequency modulation operation at a lower voltage. In the present embodiment, for example, the thickness of the substrate 220 is 1.2 μm, and the height of the protruding portions forming the optical waveguide 230 is 0.8 μm. As will be described later, the back surface (the surface facing the surface shown in FIG. 2) of the substrate 220 is adhered to the supporting plate 500 such as glass (see FIG. 5).

Further, in the optical modulation device 104, bias electrodes 262a, 262b, and 262c for adjusting the operating point by compensating for bias point fluctuations due to so-called DC drift are provided on the intermediate layer 502 formed on the substrate 220. The bias electrode 262a is used to compensate for bias point fluctuations of the nested Mach-Zehnder optical waveguides 240a and 240b. Further, the bias electrodes 262b and 262c are used to compensate for bias point fluctuations of the Mach-Zehnder optical waveguides 244a and 244b, and the Mach-Zehnder optical waveguides 244c and 244d, respectively.

These bias electrodes 262a, 262b, and 262c each extend to the shown upper side 280c of the substrate 220 and are connected to one of the signal pins 110 via the relay substrate 106. A corresponding signal pin 110 is connected to a bias control circuit provided outside the housing 102. Thus, the bias electrodes 262a, 262b, and 262c are driven 5 by the bias control circuit, and the operating point is adjusted so as to compensate for fluctuations in the bias point of the corresponding each Mach-Zehnder optical waveguide.

The bias electrode 262 is an electrode to which a direct current or low frequency electrical signal is applied, and are formed with a thickness in the range of 0.3 μm or more and 5 μm or less, for example, when the thickness of the substrate 220 is 20 μm. On the other hand, the signal electrodes 250a, 250b, 250c, and 250d described above are formed in the range of 20 μm or more and 40 μm or less, for example, in order to reduce the conductor loss of the high-frequency electrical signal to be applied. The thickness of the signal electrode 250a and the like is determined according to the thickness of the substrate 220 in order to set the impedance and microwave effective refractive index to desired values, and it can be determined thicker when the thickness of the substrate 220 is thick, and it can be determined to be thinner when the thickness of the substrate 220 is thin.

In the optical modulation device 104 configured as described above, each of the signal electrodes 250 includes eight intersections 400 that cross over the parallel waveguides 246. Then, at each of these intersections 400, the above-described disturbance modulation is generated, which can deteriorate the modulation operation of the optical modulation device 104. Therefore, in the optical modulation device 104, in particular, the intermediate layer 502 provided on the substrate 220 is formed to have different thicknesses at the action portion 300 and the intersection 400, and specifically, the thickness at the intersection 400 is thicker than the thickness at the action portion 300.

Since the cross-sectional structures in the action portion 300 are the same in the action portions 300a, 300b, 300c, and 300d, the cross-sectional structure of the action portion 300 will be described here by using the action portion 300c as an example. FIG. 5 is a cross-sectional view taken along line V-V of the optical modulator unit A shown in FIG. 3, and shows a cross-sectional structure of the action portion 300c.

The substrate 220 is adhesively fixed to the supporting plate 500 such as glass for reinforcement. On the substrate 220, protruding portions 504c-1 and 504c-2 forming parallel waveguides 246c-1 and 246c-2 of the Mach-Zehnder optical waveguide 244c, which is a convex optical waveguide, are formed. Here, the broken circles shown in FIG. 5 schematically show the field diameters of the light waves propagating through the parallel waveguides 246c-1 and 246c-2.

The intermediate layer 502 is formed on the substrate 220, and the signal electrode 250c and the ground electrodes 270c and 270d are formed on the intermediate layer 502. The intermediate layer 502 is, for example, SiO₂ (silicon dioxide), and has a thickness t1 in the action portion 300c. The clearance W1 between the signal electrode 250c and the ground electrodes 270c and 270d is determined from various design conditions including an impedance required for the coplanar transmission line formed by the signal electrode 250c and the ground electrodes 270c and 270d and the width a of protruding portions 504c-1 and 504c-2 configuring the parallel waveguides 246c-1 and 246c-2, according to the related art.

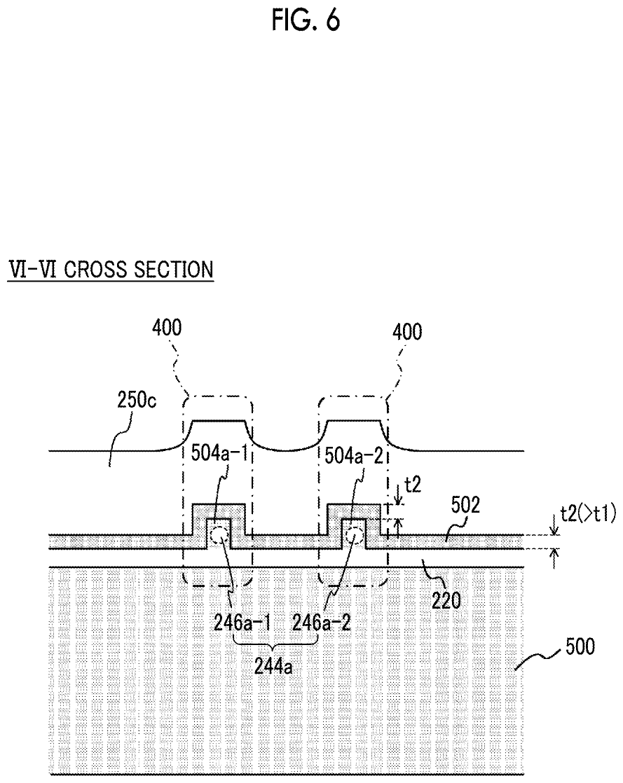

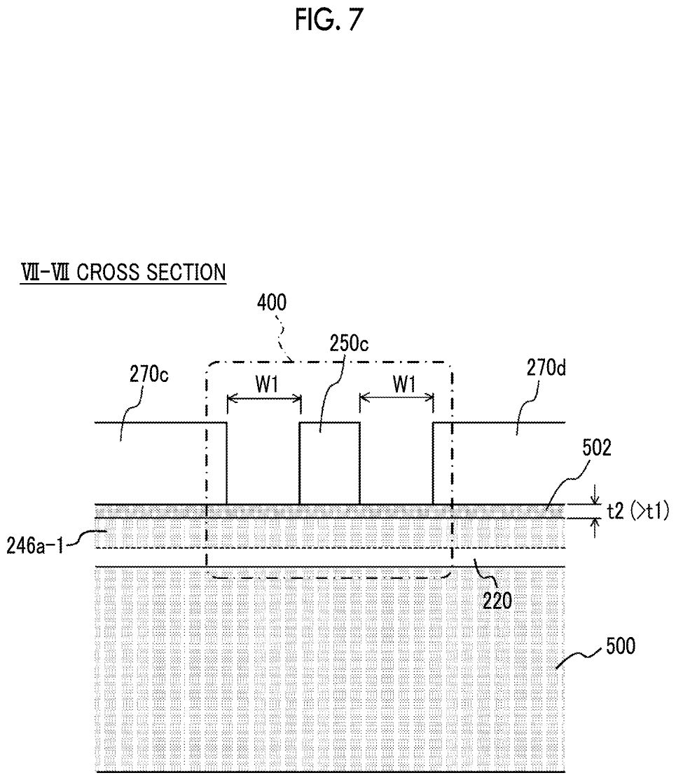

FIG. 6 is a cross-sectional view taken along line VI-VI relating to the signal electrode 250c at the portion of two intersections 400 between the signal electrode 250c and the parallel waveguides 246a-1 and 246a-2, in the optical folded part B shown in FIG. 4. Further, FIG. 7 is a cross-sectional view taken along line VII-VII relating to the parallel waveguide 246a-1 at the portion of the intersection 400 between the signal electrode 250c and the parallel waveguide 246a-1, in the optical folded part B shown in FIG. 4. Here, it should be understood that the cross-sectional structure of the other intersection 400 in the optical folded part B is also the same as the cross-sectional structure shown in FIGS. 6 and 7.

In FIG. 6, on the substrate 220, protruding portions 504a-1 and 504a-2 forming parallel waveguides 246a-1 and 246a-2 of the Mach-Zehnder optical waveguide 244a, which is a convex optical waveguide, are formed. Here, the broken circles shown in FIG. 6 schematically show the field diameters of the light waves propagating through the parallel waveguides 246a-1 and 246a-2, as in FIG. 5.

In these intersections 400 shown in FIGS. 6 and 7, the intermediate layer 502 is formed on the substrate 220, and the signal electrode 250c and the ground electrodes 270c and 270d are formed on the intermediate layer 502, similar to the action portion 300c shown in FIG. 4. However, unlike the configuration of the action portion 300c shown in FIG. 4, in the intersection 400 shown in FIGS. 6 and 7, the intermediate layer 502 is formed to have a thickness t2 (>t1) thicker than the thickness t1 in the action portion 300c.

With the above configuration, since the electric field applied from the signal electrode 250 to the parallel waveguide 246 at the intersection 400 is reduced compared to the electric field applied from the signal electrode 250 to the parallel waveguide 246 at the action portion 300, the degree or intensity of the disturbance modulation generated at individual intersections 400 is effectively reduced with respect to the normal optical modulation intensity at the action portion 300. Then, as a result of reducing the disturbance modulation at the individual intersections 400, the addition effect of the disturbance modulation from the plurality of intersections 400 formed along the respective parallel waveguides 246 is also reduced, and good operating characteristics can be achieved as a whole of the optical modulation device 104.

Here, in order to effectively reduce the electric field strength generated in the parallel waveguide 246 at the intersection 400, for example, the thickness t2 of the intermediate layer 502 at the intersection 400 is preferably larger than ½ times the height b of the protruding portion (protruding portion 504c-1 or the like) of the parallel waveguide 246 in the action portion 300, and more preferably thicker than the height b to effectively halve or offset the height of the protruding portion formed to increase the electric field efficiency.

The intermediate layer 502 can be formed to have a thickness t1 on the left side in the drawing and a thickness t2 on the right side in the drawing, for example, with any position on the substrate 220 between the portion where the optical modulator unit A is formed and the portion where the optical folded part B is formed, for example, the position of the line 282 shown in FIG. 2 as a boundary, such that the thickness of the intermediate layer 502 is t1 and t2 (>t1) at the action portion 300 and the intersection 400, respectively.

However, the mode of changing the thickness of the intermediate layer 502 in the plane on the substrate 220 is not limited to the above, and may be any mode as long as the action portion 300 and the intersection 400 have thicknesses t1 and t2, respectively. Since the thickness of the intermediate layer 502 affects the impedance of the coplanar transmission line formed by the signal electrode 250 and the ground electrode 270 provided thereon, the intermediate layer 502 is preferably formed such that its thickness changes stepwise or continuously from t1 to t2 such that the impedance does not change sharply depending on the in-plane position on the substrate 220.

Specifically, for example, in FIG. 2, by using a region sandwiched between two lines 282 and 284, provided in any position between the optical modulator unit A and the optical folded part B as a transition region in which the thickness of the intermediate layer 502 is changed, in this region, the intermediate layer 502 can be formed such that the thickness increases stepwise or continuously from t1 to t2 from the left side to the right in the drawing.

Here, in the first embodiment described above, the intermediate layer 502 is formed of a single layer, but the configuration of the intermediate layer 502 is not limited to this. The intermediate layer 502 may be formed of a plurality of layers. Further, for example, the intermediate layer 502 may be formed of more layers than the number of layers in the action portion 300, at the intersection 400.

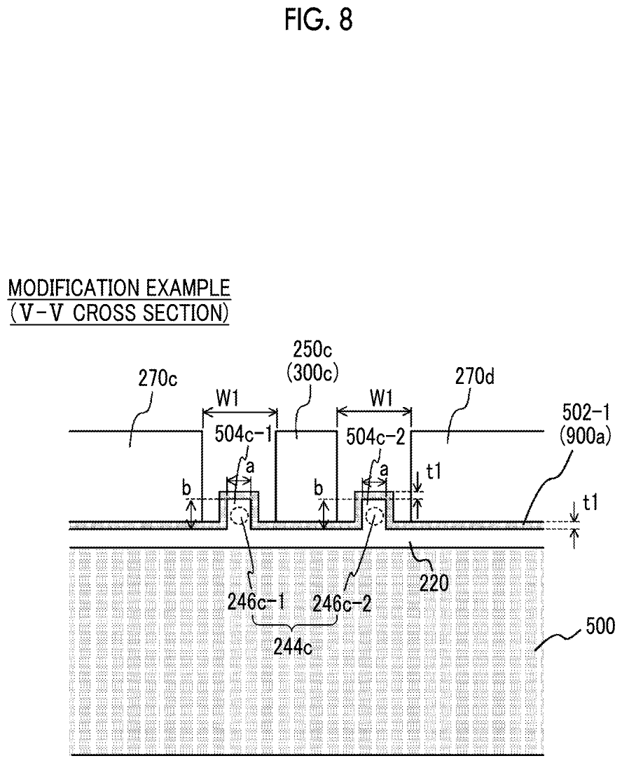

FIGS. 8, 9, and 10 are diagrams illustrating the configurations of the intermediate layer 502-1 which is a modification example of the intermediate layer 502 that can be used in the optical modulation device 104 according to the first embodiment, and correspond to FIG. 5 (cross-sectional view taken along line V-V), FIG. 6 (cross-sectional view taken along line VI-VI), and FIG. 7 (cross-sectional view taken along line VII-VII) for the optical modulation device 104 shown in FIGS. 2, respectively. In addition, in FIGS. 8, 9, and 10, the same constituent elements as the constituent elements shown in FIGS. 5, 6, and 7 are denoted by the same reference numerals as the reference numerals in FIGS. 5, 6, and 7, and the above description with respect to FIGS. 5, 6, and 7 will be incorporated herein.

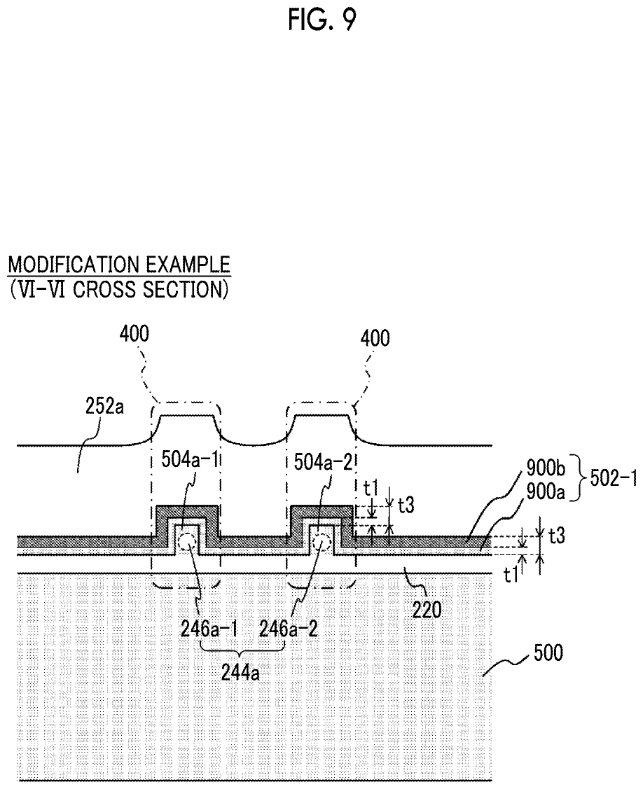

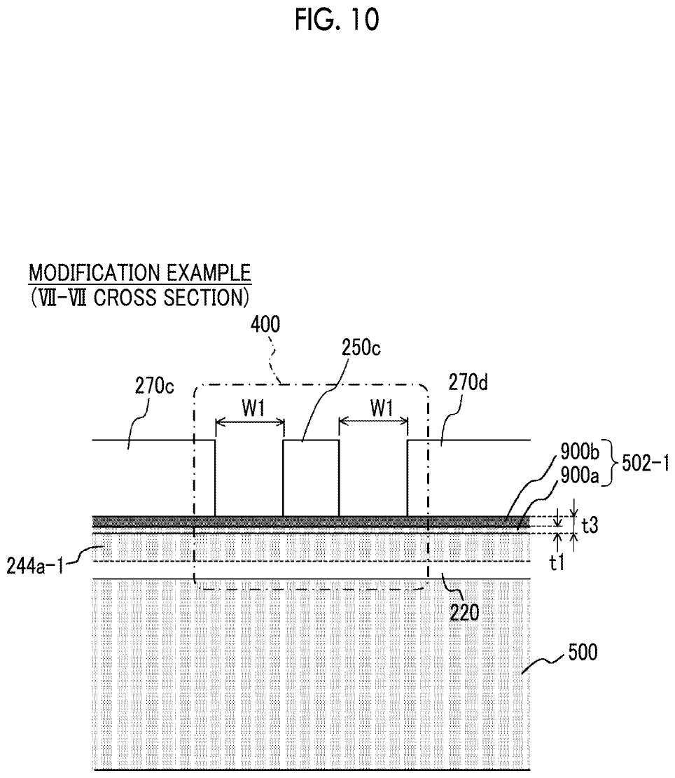

The intermediate layer 502-1 is formed of a single layer (the number of layers 1) at the action portion 300, and is formed of layers of 2 which is larger than the number of layers 1 in the action portion 300, at the intersection 400. Specifically, the intermediate layer 502-1 is formed of one layer having a thickness t1 in the action portion 300c shown in FIG. 8 in the same manner as the intermediate layer 502 shown in FIG. 5. On the other hand, in the intersection 400 shown in FIGS. 9 and 10, unlike the intermediate layer 502 shown in FIGS. 6 and 7, the intermediate layer 502-1 is formed of two layers, the first layer 900a and the second layer 900b.

More specifically, in the first layer 900a, the intermediate layer 502-1 in the action portion 300c shown in FIG. 8 extends to the portion of the intersection 400. In that sense, the intermediate layer 502-1 is formed of two layers, the first layer 900a and the second layer 900b, at the intersection 400c, and is formed of only the first layer 900a at the action portion 300c.

In this way, by configuring the intermediate layer 502-1 with two layers of the first layer 900a and the second layer 900b at the intersection 400, for example, while the first layer 900a is made of an inorganic material to satisfy the requirements for electrical characteristics such as insulating properties and dielectric constant, the second layer 900b is made of a material suitable for forming a thick film, thereby easily forming the intermediate layer 502-1 at the intersection 400 thick.

As the configuration of the intermediate layer 502-1, for example, the first layer 900a can be made of SiO₂ and the second layer 900b can be made of resin. The resin configuring the second layer 900b is, for example, a photoresist, which is a so-called photosensitive permanent film containing a coupling agent (crosslinking agent) and in which the crosslinking reaction proceeds by heat and is cured.

### Second Embodiment

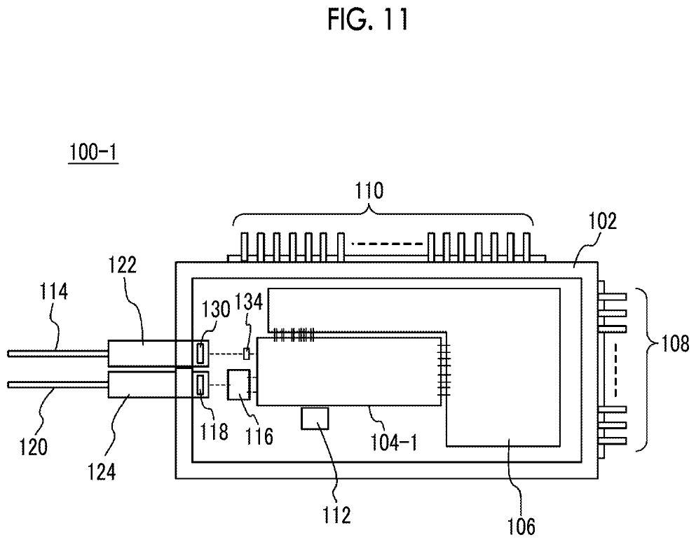

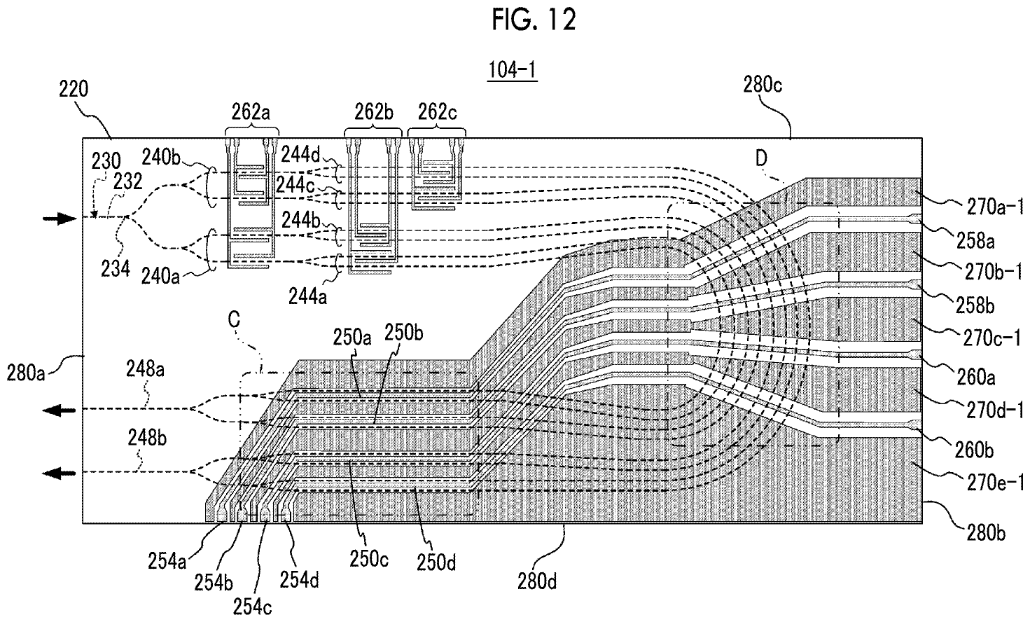

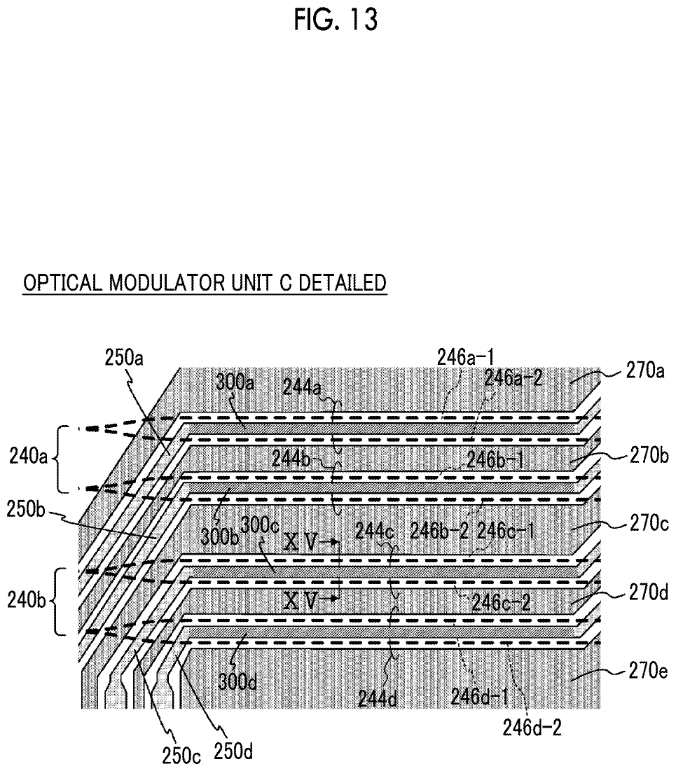

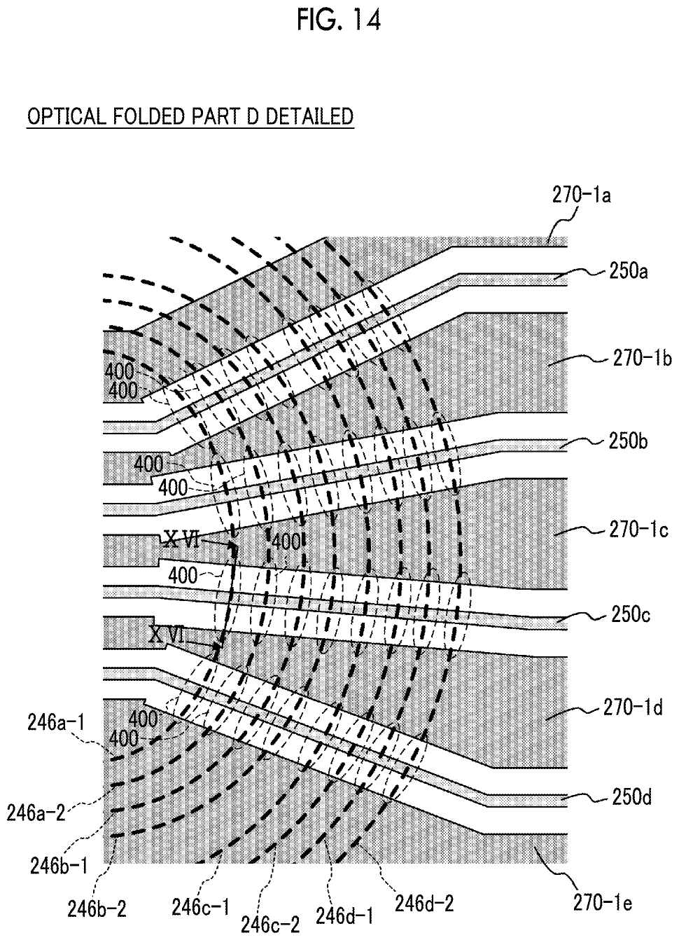

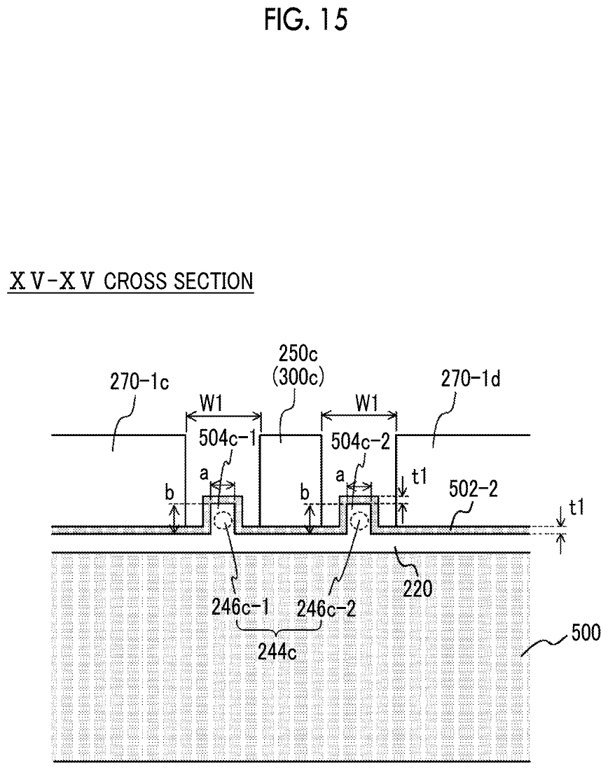

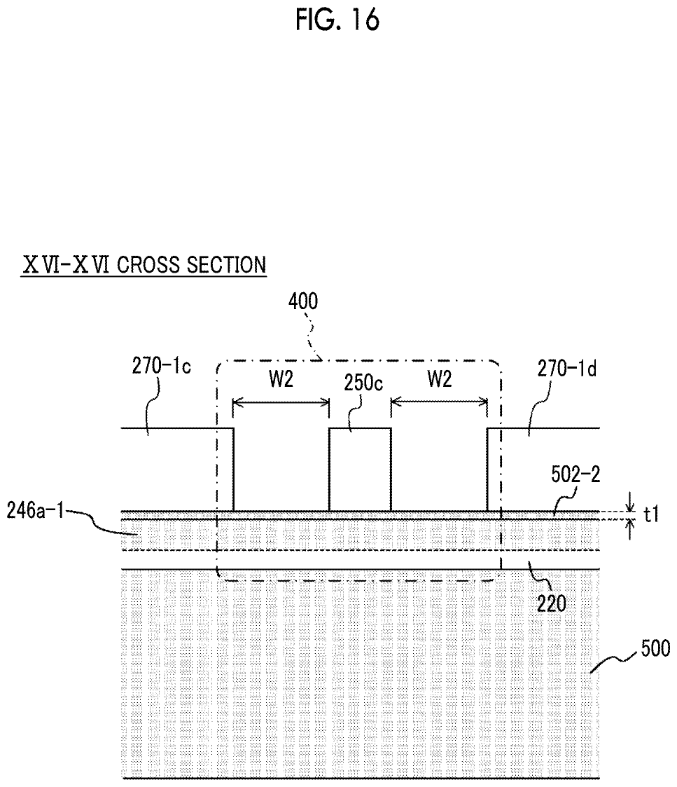

Next, a second embodiment will be described. FIG. 11 is a diagram illustrating a configuration of an optical modulator 100-1 according to a second embodiment of the present invention. Further, FIG. 12 is a diagram illustrating a configuration of an optical modulation device 104-1 included in the optical modulator 100 illustrated in FIG. 11. FIGS. 13 and 14 are partial detailed views of the optical modulator unit C and the optical folded part D of the optical modulation device 104-1 shown in FIG. 12, respectively. In addition, FIG. 15 is a cross-sectional view taken along line XV-XV of the optical modulator unit C shown in FIG. 13, and FIG. 16 is a cross-sectional view taken along line XVI-XVI of the optical folded part D shown in FIG. 14.

In addition, in FIGS. 11, 12, 13, 14, 15, and 16, the same constituent elements as in the optical modulator 100 according to the first embodiment shown in FIGS. 1, 2, 3, 4, 5, and 7 are denoted by the same reference numerals as the reference numerals in FIGS. 1, 2, 3, 4, 5, and 7, and the above description for FIGS. 1, 2, 3, 4, 5, and 7 will be incorporated herein.

The optical modulator 100-1 has the same configuration as the optical modulator 100 shown in FIG. 1, but is different in that an optical modulation device 104-1 is provided instead of the optical modulation device 104 as the optical waveguide device. The optical modulation device 104-1 has the same configuration as the optical modulation device 104 according to the first embodiment shown in FIG. 2, and the nested Mach-Zehnder optical waveguide 240 includes the optical modulator unit C and the optical folded part D. The optical modulator unit C and the optical folded part D of the nested Mach-Zehnder optical waveguide 240 shown in FIG. 12 are the same as the optical modulator unit A and the optical folded part B of the nested Mach-Zehnder optical waveguide 240 shown in FIG. 2, but the configuration around the parallel waveguide 246 (specifically, the configuration of the intermediate layer, the signal electrode, and the ground electrode) is different from the configuration of the optical modulator unit A and the optical folded part B.

The optical modulation device 104-1 has the same configuration as the optical modulation device 104 according to the first embodiment shown in FIG. 2, but is different in that an intermediate layer 502-2 is provided instead of the intermediate layer 502, and ground electrodes 270-1a, 270-1b, 270-1c, 270-1d, and 270-1e are provided instead of the ground electrodes 270a, 270b, 270c, 270d, and 270e. Hereinafter, the ground electrodes 270-1a, 270-1b, 270-1c, 270-1d, and 270-1e are collectively referred to as ground electrodes 270-1.

The intermediate layer 502-2 has the same configuration as the intermediate layer 502, but has the same thickness t1 at the action portion 300 and the intersection 400 (FIGS. 15 and 16).

The ground electrode 270-1 has the same configuration as the ground electrode 270 of the optical modulation device 104 shown in FIG. 2, but is different in that the distance between the signal electrode 250 and the ground electrode 270-1 at the intersection 400 is a value W2 (>W1) larger than the distance W1 (FIG. 15) between the signal electrode 250 and the ground electrode 270-1 at the action portion 300 (FIG. 16). Here, although FIG. 15 shows the cross-sectional configuration of the action portion 300c, it should be understood that the other action portions 300a, 300b, and 300d also have the same cross-sectional configuration as that of FIG. 15. Further, FIG. 16 shows a cross-sectional configuration of the intersection 400 between the parallel waveguide 246a-1 and the signal electrode 250c, but it should be understood that the intersection 400 between the other parallel waveguide 246 and the signal electrode 250 has the same cross-sectional configuration as in FIG. 16.

In the optical modulation device 104-1 having the above configuration, since the distance W2 between the signal electrode 250 and the ground electrode 270-1 at the intersection 400 between the parallel waveguide 246 and the signal electrode 250 is set to be wider than the distance W1 between the signal electrode 250 and the ground electrode 270-1 at the action portion 300, the electric field applied from the signal electrode 250 to the parallel waveguide 246 at the intersection 400 is reduced compared to the electric field applied from the signal electrode 250 to the parallel waveguide 246 at the action portion 300. Therefore, the degree or intensity of the disturbance modulation generated at each intersection 400 is reduced as compared with the configuration in the related art in which the clearance between the signal electrode 250 and the ground electrode 270 is the same over the entire signal electrode 250, thereby achieving good operating characteristics of the optical modulation device 104-1 as a whole.

In addition, in order to effectively reduce the electric field strength generated in the parallel waveguide 246 at the intersection 400, the clearance W2 between the signal electrode 250 and the ground electrode 270-1 at the intersection 400 is preferably 1.5 times or more the width a of the protruding portion (for example, the protruding portion 504c-1 or the like) of the parallel waveguide 246 at the action portion 300, and more preferably three times or more the width a.

Here, since the clearance between the signal electrode 250 and the ground electrode 270 affects the impedance of the coplanar transmission line formed by the signal electrode 250 and the ground electrode 270, the clearance is preferably provided to change stepwise and/or continuously such that the impedance does not change sharply depending on the in-plane position on the substrate 220.

In the present embodiment, the ground electrode 270-1 is formed such that the clearance between the signal electrode 250 and the ground electrode 270-1 stepwise and/or continuously decreases from W2 to W1 from the intersection 400 to the action portion 300. Specifically, in the present embodiment, the ground electrode 270-1 is divided into four portions along the signal electrode 250, and is formed to have different clearances between the ground electrode 270-1 and the signal electrode 250 to change stepwise or continuously.

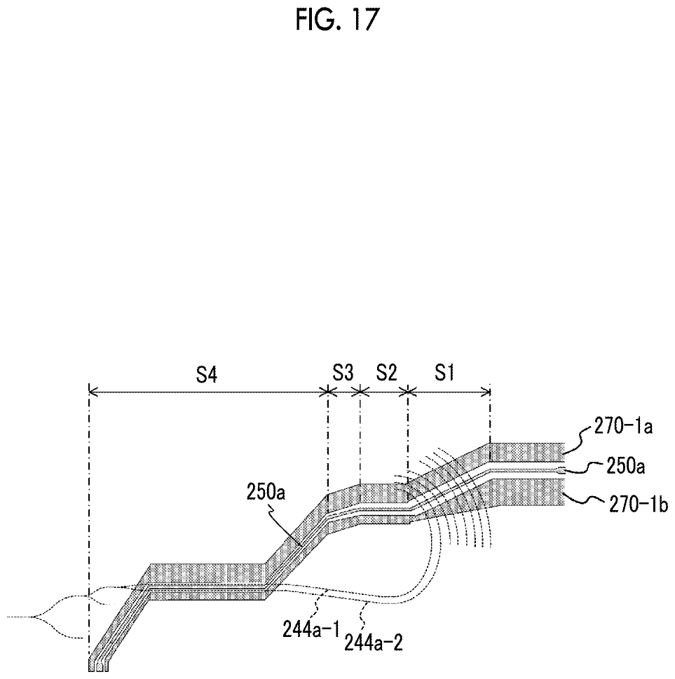

As an example, FIG. 17 is a diagram showing extracted parts of the signal electrode 250a and the ground electrodes 270-1a and 270-1b of the optical modulation device 104-1 shown in FIG. 12. It should be understood that the clearance between the other signal electrodes 250b, 250c, and 250d and the corresponding ground electrode 270-1 is also provided in the same manner as the clearance between the signal electrode 250a and the ground electrodes 270-1a and 270-1b shown in FIG. 17.

In FIG. 17, the ground electrodes 270-1a and 270-1b are divided into four sections S1, S2, S3, and S4, and in each section, are formed such that the clearance between the ground electrodes 270-1a and 270-1b and the signal electrode 250a is stepwise or continuously narrowed from W2 to W1. More specifically, the clearance is set to W2 in the section S1 including the intersection 400, and the clearance is set to W1 in the section S4 including the action portion 300. Further, between the sections S1 and S4, sections S2 and S3 are provided in order from the sections S1 to S4. In the section S2 adjacent to the section S1 having the clearance W2, the clearance is set to an intermediate clearance W3 that is smaller than W2 and larger than W1. Further, in the section S3 between the section S2 and the section S4, the clearance is provided in a tapered shape such that the clearance is continuously changed from W3 to W1 from the section S2 to S1.

In FIGS. 12 and 17, the ground electrode 270-1 is drawn such that the edges facing the signal electrode 250 have right-angled corner portions in plan view at the boundary between the section S1 and the section S2, but these corner portions are preferably provided, for example, in a curved shape such that the above-described impedance does not change sharply at these positions.

### Third Embodiment

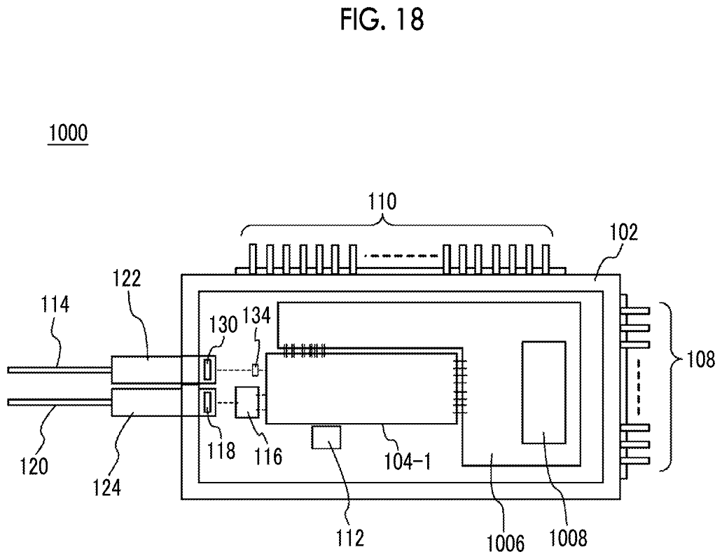

Next, a third embodiment of the present invention will be described. The present embodiment is an optical modulation module 1000 using the optical modulation device 104 included in the optical modulator 100 according to the first embodiment. FIG. 18 is a diagram showing the configuration of an optical modulation module 1000 according to the present embodiment. In FIG. 18, the same constituent elements as in the optical modulator 100 according to the first embodiment shown in FIG. 1 are denoted by the same reference numerals as the reference numerals in FIG. 1, and the above description for FIG. 1 will be incorporated herein.

The optical modulation module 1000 has the same configuration as the configuration of the optical modulator 100 illustrated in FIG. 1, but differs from the optical modulator 100 in that a circuit substrate 1006 is provided instead of the relay substrate 106. The circuit substrate 1006 includes a drive circuit 1008. The drive circuit 1008 generates a high-frequency electrical signal for driving the optical modulation device 104 based on, for example, a modulation signal supplied from the outside via the signal pins 108, and outputs the generated high-frequency electrical signal to the optical modulation device 104.

Since the optical modulation module 1000 having the above configuration includes the optical modulation device 104 similar to the optical modulator 100 according to the first embodiment described above, disturbance modulation generated at the intersection 400 can be reduced to achieve good modulation operation, similar to the optical modulator 100.

In the present embodiment, the optical modulation module 1000 includes the optical modulation device 104 as an example, but may include the optical modulation devices according to the modification examples shown in FIGS. 8 and 9 or the optical modulation device 104-1 according to the second embodiment shown in FIG. 12.

### Fourth Embodiment

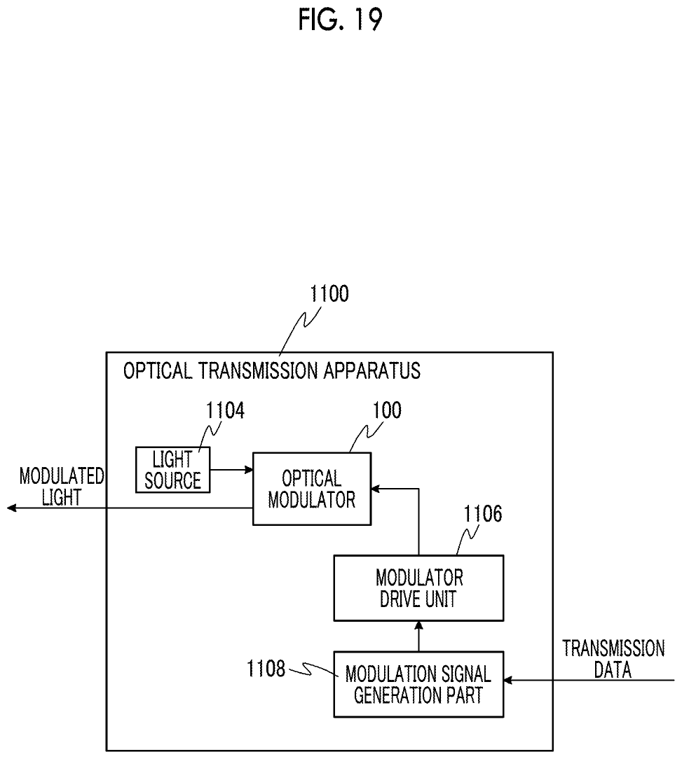

Next, a fourth embodiment of the present invention will be described. The present embodiment is an optical transmission apparatus 1100 equipped with the optical modulator 100 according to the first embodiment. FIG. 19 is a diagram showing a configuration of an optical transmission apparatus 1100 according to the present embodiment. The optical transmission apparatus 1100 includes an optical modulator 100, a light source 1104 that inputs light to the optical modulator 100, a modulator drive unit 1106, and a modulation signal generation part 1108. In addition, instead of the optical modulator 100 and the modulator drive unit 1106, the optical modulator 100-1 according to the second embodiment or the optical modulation module 1000 according to the third embodiment can be used.

The modulation signal generation part 1108 is an electronic circuit that generates an electrical signal for causing the optical modulator 100 to perform a modulation operation, which generates, based on transmission data given from the outside, a modulation signal which is a high-frequency signal for causing the optical modulator 100 to perform an optical modulation operation according to the modulation data, and outputs the modulation signal to the modulator drive unit 1106.

The modulator drive unit 1106 amplifies the modulation signal input from the modulation signal generation part 1108 and outputs four high-frequency electrical signals for driving four signal electrodes 250a, 250b, 250c, and 250d of the optical modulation device 104 included in the optical modulator 100. As described above, instead of the optical modulator 100 and the modulator drive unit 1106, for example, the optical modulation module 1000 provided with a drive circuit 1008 including a circuit corresponding to the modulator drive unit 1106 inside the housing 102 can also be used.

The four high-frequency electrical signals are input to the signal pins 108 of the optical modulator 100 to drive the optical modulation device 104 and the like. Thus, the light output from the light source 1104 is, for example, DP-QPSK modulated by the optical modulator 100 to become modulated light, and is output from the optical transmission apparatus 1100.

In particular, in the optical transmission apparatus 1100, as in the optical modulator 100 according to the first embodiment described above, the optical modulator 100 including the optical modulation device 104 or the optical modulator 100-1 including the optical modulation device 104-1 or the optical modulation module 1000 are used, so that good modulation characteristics can be achieved, and good optical transmission can be performed.

The present invention is not limited to the configuration of the above embodiment and its alternative configuration, and can be implemented in various embodiments without departing from the gist thereof.

For example, in the above-described embodiment, SiO₂ is used as the material of the first layer 900a of the intermediate layers 502, 502-2, and the intermediate layer 502-1, and a photosensitive permanent film is used as the second layer 900b of the intermediate layer 502-1. However, the materials configuring the intermediate layers 502, 502-1, and 502-2 are not limited to the above materials. Any material can be used for the intermediate layers 502, 502-1, and 502-2 as long as the requirements for electrical characteristics and/or mechanical characteristics determined from the design of the optical modulation devices 104 and 104-1 are satisfied, respectively. Such materials may include, for example, an inorganic substance such as silicon nitride or a thermosetting or thermoplastic resin other than the photosensitive permanent film.

In addition, one optical modulation device may be configured by combining the characteristic configuration of the optical modulation device 104 according to the first embodiment and the optical modulation device 104-1 according to the second embodiment. For example, in the optical modulation device 104-1, the intermediate layer 502-2 may be configured such that the thickness at the intersection 400 is thicker than the thickness t1 at the action portion 300, similar to the intermediate layer 502 or the intermediate layer 502-1. Thus, it is possible to further reduce the generation of disturbance modulation at the intersection 400 and to implement a better optical modulation operation.

Further, in the above-described embodiments, as an example of the optical waveguide device, the optical modulation device 104 formed of the substrate 220 of LN (LiNbO₃) is shown, but without being limited to this, the optical waveguide device can be a device having any function (in addition to optical modulation, optical switch, optical directional coupler, or the like), which is formed of a substrate of any material (in addition to LN, InP, Si, or the like). Such devices can be, for example, so-called silicon photonics waveguide devices.

In the above-described embodiments, the substrate 220 is an X-cut (the normal direction of the substrate is the X-axis of the crystal axis) LN substrate (so-called X-plate) as an example, but a Z-cut LN substrate can also be used as the substrate 220.

As described above, the optical modulation device 104, which is an optical waveguide device configuring the optical modulator 100 according to the first embodiment described above, includes the substrate 220 on which the optical waveguide 230 is formed, the intermediate layer 502 formed on the substrate 220, and the signal electrode 250 and the ground electrode 270 formed on the intermediate layer 502. The optical waveguide 230 includes a protruding portion (for example, the protruding portions 504c-1 and 504c-2) extending on the substrate 220. Further, the signal electrode 250 has an action portion 300 that extends along, for example, the parallel waveguide 246, which is a part of the optical waveguide 230, and controls a light wave propagating through the parallel waveguide 246, and an intersection 400 that crosses over the parallel waveguide 246. Then, the intermediate layer 502 is formed such that the thickness t2 at the intersection 400 is thicker than the thickness t1 at the action portion 300.

According to this configuration, the generation of disturbance modulation at the intersections between a convex optical waveguide and a signal electrode is effectively reduced, thereby achieving good modulation operating characteristics.

Further, the intermediate layer 502 is formed such that the thickness stepwise and/or continuously increases from the action portion 300 toward the intersection 400. According to this configuration, for example, it is possible to prevent the impedance of the signal electrode 250 configuring the coplanar transmission line from changing sharply in the plane of the substrate 220.

Further, the intermediate layers 502 and 502-1 may be formed of one or a plurality of layers. The intermediate layer 502-1 is formed in which the number of layers in the intersection 400 is larger than the number of layers in the action portion 300. Specifically, the intermediate layer 502-1 is a single layer of only the first layer 900a at the action portion 300, and is formed of two layers, the first layer 900a and the second layer 900b, at the intersection 400. The intermediate layer 502-1 includes a second layer 900b made of, for example, a resin at the intersection 400. According to this configuration, for example, while the first layer 900a is made of an inorganic material to satisfy the requirements for electrical characteristics such as insulating properties and dielectric constant, the second layer 900b is made of a resin material or the like suitable for forming a thick film, thereby easily forming the intermediate layer 502-1 at the intersection 400 thick.

Further, the intermediate layer 502 is formed such that the thickness t2 at the intersection 400 is thicker than the height b of the protruding portion (for example, the protruding portion 504c-1 or the like) forming the optical waveguide 230. According to this configuration, the strength of the electric field applied to the optical waveguide 230 (specifically, the parallel waveguide 246) at the intersection 400 is sufficiently reduced, and the disturbance modulation generated at the intersection 400 can be effectively reduced.

Further, the ground electrode 270-1 is formed to have a clearance between the ground electrode 270-1 and the signal electrode 250 such that a clearance W2 at the intersection 400 is wider than a clearance W1 at the action portion 300. According to this configuration, the intermediate layer 502-2 is easily formed with a uniform thickness in the entire substrate 220, and the generation of disturbance modulation at the intersection 400 is effectively reduced, thereby achieving good modulation operating characteristics.

Further, the ground electrode 270-1 is formed such that a clearance between the ground electrode 270-1 and the signal electrode 250 is stepwise and/or continuously widened from W1 to W2 from the action portion 300 toward the intersection 400. According to this configuration, for example, it is possible to prevent the impedance of the signal electrode 250 configuring the coplanar transmission line from changing sharply in the plane of the substrate 220.

Further, the ground electrode 270 is formed such that the clearance W2 between the ground electrode 270 and the signal electrode 250 at the intersection 400 is wider than three times the width a of the protruding portion forming the optical waveguide 230 (for example, the protruding portion 504c-1 or the like forming the parallel waveguide 246). According to this configuration, the strength of the electric field applied to the optical waveguide 230 (specifically, the parallel waveguide 246) at the intersection 400 is sufficiently reduced, and the disturbance modulation generated at the intersection 400 can be effectively reduced.

Further, the optical modulator 100 according to the first embodiment includes any one optical modulation device out of the above-described optical modulation device 104 (including the above-described modification example) and the optical modulation device 104-1 which are optical waveguide devices that modulate light, a housing 102 that houses the optical waveguide device, an input optical fiber 114 that inputs light to the optical waveguide device, and an output optical fiber 120 that guides the light output by the optical waveguide device to the outside of the housing 102.

Further, the optical modulation module 1000 according to the third embodiment includes any one optical modulation device out of the optical modulation device 104 (including the modification example described above) and the optical modulation device 104-1 that modulate light, which is an optical waveguide device, and a drive circuit 1008 that drives the optical waveguide device.

Further, the optical transmission apparatus 1100 according to the fourth embodiment includes an optical modulator 100 or an optical modulation module 1000, and a modulation signal generation part 1108 which is an electronic circuit for generating an electrical signal for causing the optical modulation device 104 to perform a modulation operation.

According to these configurations, an optical modulator 100, an optical modulation module 1000, or an optical transmission apparatus 1100 having good characteristics can be achieved.

### REFERENCE SIGNS LIST

100, 100-1 Optical modulator
102 Housing
104, 104-1 Optical modulation device
106 Relay substrate
108, 110 Signal pin
112 Terminator
114 Input optical fiber
116 Optical unit
118, 130, 134 Lens
120 Output optical fiber
122, 124 Support
220 Substrate
230 Optical waveguide
232 Input waveguide
234 Branched waveguide
240a, 240b Nested Mach-Zehnder optical waveguide
244a, 244b, 244c, 244d Mach-Zehnder optical waveguide
246a-1, 246a-2, 246b-1, 246b-2, 246c-1, 246c-2, 246d-1, 246d-2 Parallel waveguide
248a, 248b Output waveguide
250a, 250b, 250c, 250d Signal electrode
252a, 252b, 252c, 252d, 254a, 254b, 254c, 254d Pad
262a, 262b, 262c Bias electrode
300, 300b, 300c, 300d Action portion
400 Intersection
500 Supporting plate
502, 502-1, 502-2 Intermediate layer
504a-1, 504a-2, 504c-1, 504c-2 Protruding portion
900a First layer
900b Second layer
1000 Optical modulation module
1006 Circuit substrate
1008 Drive circuit
1100 Optical transmission apparatus
1104 Light source
1106 Modulator drive unit
1108 Modulation signal generation part

1. An optical waveguide device comprising:
a substrate on which an optical waveguide is formed;
an intermediate layer formed on the substrate; and
a signal electrode and a ground electrode formed on the intermediate layer, wherein
the optical waveguide includes a protruding portion extending on the substrate,
the signal electrode has an action portion that extends along the optical waveguide and controls a light wave propagating through the optical waveguide, and an intersection that crosses over the optical waveguide, and
the intermediate layer is formed such that a thickness at the intersection is thicker than a thickness at the action portion.

2. The optical waveguide device according to claim 1, wherein
the intermediate layer is formed such that the thickness of the intermediate layer stepwise and/or continuously increases from the action portion toward the intersection.

3. The optical waveguide device according to claim 1 wherein
the intermediate layer is formed of one or a plurality of layers, and
the intermediate layer is formed such that the number of layers at the intersection is larger than the number of layers at the action portion.

4. The optical waveguide device according to claim 3, wherein
the intermediate layer includes a resin layer at the intersection.

5. The optical waveguide device according to claim 1, wherein
the intermediate layer is formed such that the thickness at the intersection is thicker than a height of the protruding portion forming the optical waveguide.

6. The optical waveguide device according to claim 1, wherein
the ground electrode is formed such that a clearance between the ground electrode and the signal electrode is wider at the intersection than at the action portion.

7. An optical waveguide device comprising:
a substrate on which an optical waveguide is formed;
an intermediate layer formed on the substrate; and
a signal electrode and a ground electrode formed on the intermediate layer, wherein
the optical waveguide includes a protruding portion extending on the substrate,
the signal electrode has an action portion that extends along the optical waveguide and controls a light wave propagating through the optical waveguide, and an intersection that crosses over the optical waveguide, and
the ground electrode is formed such that a clearance between the ground electrode and the signal electrode is wider at the intersection than at the action portion.

8. The optical waveguide device according to claim 7, wherein
the ground electrode is formed such that the clearance between the ground electrode and the signal electrode is stepwise and/or continuously widened from the action portion toward the intersection.

9. The optical waveguide device according to claim 7, wherein
the ground electrode is formed such that the clearance between the ground electrode and the signal electrode at the intersection is wider than three times a width of the protruding portion forming the optical waveguide.

10. An optical modulator comprising:
the optical waveguide device according to claim 1, which is an optical modulation device that modulates light;
a housing that houses the optical waveguide device;
an optical fiber that inputs light to the optical waveguide device; and
an optical fiber that guides light output by the optical waveguide device to outside the housing.

11. An optical modulation module comprising:
the optical waveguide device according to claim 1, which is an optical modulation device that modulates light; and
a drive circuit that drives the optical waveguide device.

12. An optical transmission apparatus comprising:
the optical modulator according to claim 10; and
an electronic circuit that generates an electrical signal for causing the optical waveguide device to perform a modulation operation.

13. An optical transmission apparatus comprising:
the optical modulation module according to claim 11; and
an electronic circuit that generates an electrical signal for causing the optical waveguide device to perform a modulation operation.

14. The optical waveguide device according to claim 6, wherein
the ground electrode is formed such that the clearance between the ground electrode and the signal electrode is stepwise and/or continuously widened from the action portion toward the intersection.

15. The optical waveguide device according to claim 6, wherein
the ground electrode is formed such that the clearance between the ground electrode and the signal electrode at the intersection is wider than three times a width of the protruding portion forming the optical waveguide.

16. An optical modulator comprising:
the optical waveguide device according to claim 7, which is an optical modulation device that modulates light;
a housing that houses the optical waveguide device;
an optical fiber that inputs light to the optical waveguide device; and
an optical fiber that guides light output by the optical waveguide device to outside the housing.

17. An optical modulation module comprising:
the optical waveguide device according to claim 7, which is an optical modulation device that modulates light; and
a drive circuit that drives the optical waveguide device.

18. An optical transmission apparatus comprising:
the optical modulator according to claim 16; and
an electronic circuit that generates an electrical signal for causing the optical waveguide device to perform a modulation operation.

19. An optical transmission apparatus comprising:
the optical modulation module according to claim 17; and
an electronic circuit that generates an electrical signal for causing the optical waveguide device to perform a modulation operation.
